(19) United States
(12) Patent Application Publication
(10) Pub. No.: US 2025/0342702 A1
(43) Pub. Date: Nov. 6, 2025

(54) CONTROL DEVICE, CARGO AREA MONITORING SYSTEM, AND NOTIFICATION METHOD

(71) Applicant: DENSO CORPORATION, Kariya-city (JP)

(72) Inventors: SHINYA AOKI, Kariya-city (JP); KOUEI KIYO, Kariya-city (JP)

(21) Appl. No.: 19/196,511

(22) Filed: May 1, 2025

(30) Foreign Application Priority Data
May 6, 2024 (JP) 2024-075026

(51) Int. Cl. G06V 20/56; B60Q 9/00; G06V 10/22; G06V 10/25; G06V 40/10

(52) U.S. Cl. CPC G06V 20/56; B60Q 9/00; G06V 10/235; G06V 10/25; G06V 40/10

(57) ABSTRACT

In a notification method for a vehicle, a cargo area image photographed by an image device that photographs a cargo area of the vehicle is acquired. A change in a detection target is detected in the cargo area based on the cargo area image. A user of the vehicle is notified of the change of the detection target by at least one of sound output from a sound output unit and a display of a notification image from an image output unit when detecting the change in the detection target.

### CROSS REFERENCE TO RELATED APPLICATION

The present application claims the benefit of priority from Japanese Patent Application No. 2024-075026 filed on May 6, 2024. The entire disclosure of the above application is incorporated herein by reference.

### TECHNICAL FIELD

The disclosure in this specification relates to a control device, a cargo area monitoring system, and a notification method.

### BACKGROUND ART

A conceivable technique teaches a load shift monitoring device. The cargo collapse monitoring device photographs the inside of the cargo area and displays the photographed image on a display device in front of the driver's seat.

### SUMMARY OF INVENTION

According to an example, in a notification method for a vehicle, a cargo area image photographed by an image device that photographs a cargo area of the vehicle is acquired. A change in a detection target is detected in the cargo area based on the cargo area image. A user of the vehicle is notified of the change of the detection target by at least one of sound output from a sound output unit and a display of a notification image from an image output unit when detecting the change in the detection target.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a cargo area monitoring system;

FIG. 2 is a diagram showing a side view of a vehicle;

FIG. 3 is a diagram illustrating a cargo area region;

FIG. 4 is a diagram illustrating protrusion detection;

FIG. 5 is a diagram illustrating protrusion detection;

FIG. 6 is a diagram illustrating protrusion detection;

FIG. 7 is a diagram illustrating human detection;

FIG. 8 is a diagram illustrating sway detection;

FIG. 9 is a diagram showing an example of a notification image;

FIG. 10 is a diagram showing an example of a notification image;

FIG. 11 is a diagram showing an example of a notification image;

FIG. 12 is a diagram showing an example of a notification image;

FIG. 13 is a diagram showing an example of a notification image;

FIG. 14 is a diagram showing an example of a notification image;

FIG. 15 is a flowchart showing a process in the periphery monitoring ECU;

FIG. 16 is a flowchart showing a process in the periphery monitoring ECU;

FIG. 17 is a flowchart showing a process in the periphery monitoring ECU;

FIG. 18 is a flowchart showing a process in the periphery monitoring ECU;

FIG. 19 is a flowchart showing a process in the periphery monitoring ECU; and

FIG. 20 is a flowchart showing a process in the periphery monitoring ECU.

### DETAILED DESCRIPTION

The system in the conceivable technique simply continues to display the photographed image on a display device in front of the driver's seat, but does not detect and notify the driver of a change in the cargo area, so that it is difficult for the driver to notice the change in the cargo area.

One object of the present embodiments is to provide a control device that allows a user to easily recognize a change in the detection target within the cargo area.

A control device in the present embodiments is a control device for use in a vehicle, and includes: an image acquisition unit that acquires a cargo area image photographed by an image device that photographs an image of the cargo area of the vehicle; a cargo area detection unit that detects a change in a detection object in the cargo area based on the cargo area image; and a notification processing unit that notifies a user of the vehicle of the change in the detection object by at least one of sound output by a sound output unit and the display of a notification image by an image output unit when the cargo area detection unit detects the change of the detection target.

A cargo area monitoring system in the present embodiments is a cargo area monitoring system for use in a vehicle, and includes: an image device for photographing a cargo area of a vehicle; and a control device. The control device includes: an image acquisition unit that acquires a cargo area image photographed by the image device; a cargo area detection unit that detects a change in a detection object in the cargo area based on the cargo area image; and a notification processing unit that notifies a user of the vehicle of the change in the detection object by at least one of sound output by a sound output unit and the display of a notification image by an image output unit when the cargo area detection unit detects the change of the detection target.

Also a notification method in the present embodiments is a notification method for use in a vehicle, and includes a process executed by at least one processor. The process includes steps of: acquiring a cargo area image photographed by an image device that photographs a cargo area of the vehicle; detecting a change of a detection object in the cargo area based on the cargo area image; and notifying a user of the vehicle of the change of the detection object by at least one of sound output from a sound output unit and the display of a notification image from an image output unit when detecting the change in the detection object.

According to these features, when a change in the detection object within the cargo area is detected based on a cargo area image showing the cargo area, the user is notified of the change in the detection target by at least one of the sound output and the display of a notification image. In this way, a change in the detection target is used as a trigger to notify the user, so that it is easier for the user to recognize the change in the detection target in the cargo area.

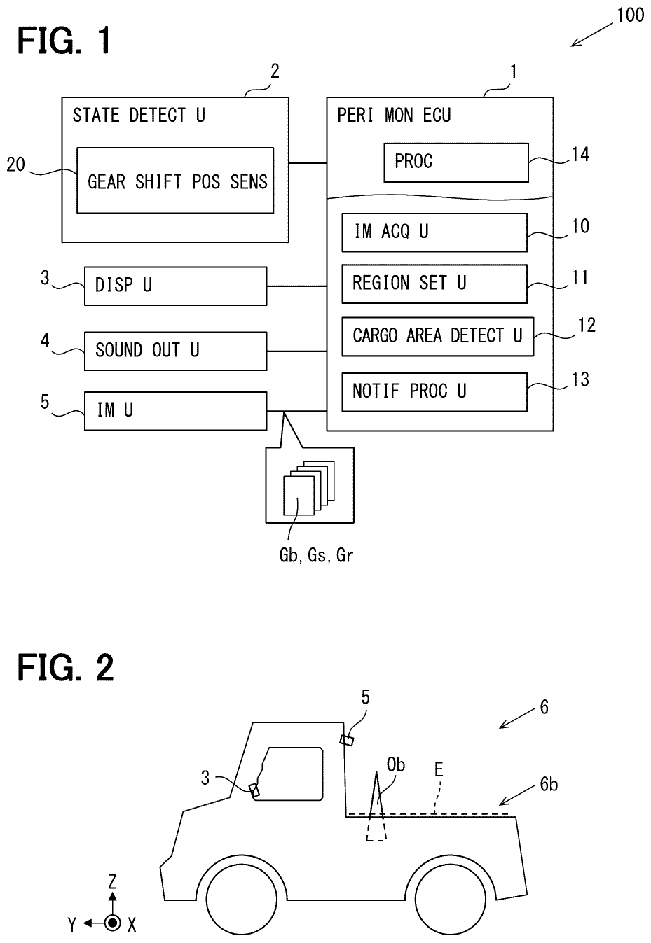

The cargo area monitoring system 100 shown in FIG. 1 is mounted on a vehicle 6. The cargo area monitoring system 100 is a system that monitors the cargo area 6b of the vehicle 6, and notifies the user of the vehicle 6 when a change in the detection target Ob is detected. The vehicle 6 is a cargo vehicle (e.g., a pickup truck) with an open upper portion of the cargo area 6b. The cargo area monitoring system 100 includes a state detection unit 2, a display unit 3, a sound output unit 4, an image unit 5 and a periphery monitoring ECU 1. The minimum components included in the cargo area monitoring system 100 are the periphery monitoring ECU 1 and the image unit 5.

In this disclosure, the concept of a right-handed three-dimensional coordinate system having mutually orthogonal X-axis, Y-axis, and Z-axis will be introduced for explanation (see FIG. 2). Specifically, the traveling direction of the vehicle 6 is defined as the forward direction, and the direction opposite to the forward direction is defined as the backward direction. The Y-axis is defined along the front-to-rear direction. The X-axis is defined along the vehicle width direction. The Z axis is defined along the vertical direction of the vehicle 6. The downward direction is also the direction of gravity.

The state detection unit 2 is a sensor that detects the state of the vehicle 6. The state detection unit 2 includes a brake sensor, an accelerator sensor, a gear shift position sensor 20, a vehicle speed sensor, an acceleration sensor, and the like. The gear shift position sensor 20 detects a shift position of a shift lever. Each sensor outputs data indicating a current value (that is, the detection result) of the physical state amount, which is the detection target, to the LAN. The output data of each sensor is acquired by the periphery monitoring ECU 1 and the like via the LAN. The types of sensors used by the periphery monitoring ECU 1 as the state detection unit 2 may be appropriately designed, and it is not necessary for the periphery monitoring ECU 1 to include all of the above-described sensors.

The display unit 3 is an image output unit that displays a predetermined image to the driver of the vehicle 6. The display unit 3 is a liquid crystal display, an organic EL display, or the like. The display unit 3 is disposed in front of the driver's seat inside the passenger compartment of the vehicle 6, and is fixed to a fixation member (e.g., an instrument panel, or the like) on the vehicle 6 side with the display screen facing the driver's seat. The display unit 3 notifies the driver of the vehicle 6 of predetermined information by displaying an image. The display unit 3 outputs visual information to the driver based on the image output data input from the periphery monitoring ECU 1. The display output data is data relating to a notification image Pi output by a notification processing unit 13, which will be described later.

The display unit 3 has a touch panel function. The display unit 3 detects, for example, a touch operation, a swipe operation, and the like, performed by the user on the display screen. The display unit 3 transmits operation information input by the user to the periphery monitoring ECU 1.

The sound output unit 4 is an in-vehicle speaker. The sound output unit 4 notifies the driver of the vehicle 6 of predetermined information by sound. The sound output unit 4 notifies the user by voice based on the sound output data input from the periphery monitoring ECU 1. The sound output data is data output by a notification processing unit 13, which will be described later.

The image unit 5 is an imaging device that captures an image of the cargo area 6b of the vehicle 6. As shown in FIG. 2, the image unit 5 is disposed on the upper side of the rear part of the cabin of the vehicle 6. The image unit 5 is also defined as a bed camera. The number and arrangement of the image units 5 may be arbitrary.

The image unit 5 captures an image of the cargo area 6b at predetermined time intervals. The image unit 5 transmits the cargo area image Gb to the periphery monitoring ECU 1. The cargo area image Gb is an image of the cargo area 6b captured by the image unit 5. The timing at which the image unit 5 transmits the cargo area image Gb may be arbitrary.

The image unit 5 captures an image of the cargo area 6b when the vehicle 6 stops. The time when the vehicle stops is when it is detected that the shift lever is in the parking position (hereinafter, referred to as the P position). Alternatively, the time when the vehicle stops may be when the shift lever is set to the P position and it is detected that the parking brake turns on. The image unit 5 transmits a cargo area image Gb captured at the time when the vehicle 6 just stops to the periphery monitoring ECU 1 as a vehicle stop image Gs (see FIG. 1).

The image unit 5 captures an image of the cargo area 6b at predetermined time intervals even while the vehicle 6 is stopping. The image unit 5 transmits a cargo area image Gb captured while the vehicle 6 is stopping to the periphery monitoring ECU 1 as a vehicle stop image Gs.

The image unit 5 captures an image of the cargo area 6b when the vehicle 6 starts moving again. The time when the vehicle 6 starts moving again is when the shift lever is changed from the P position to a position other than the P position after the vehicle 6 has stopped. Alternatively, the time when the vehicle starts moving again may be when it is detected that the ignition switch has been turned on by the user. The image unit 5 transmits the cargo area image Gb captured when the vehicle 6 starts moving again to the periphery monitoring ECU 1 as a restart image Gr (see FIG. 1).

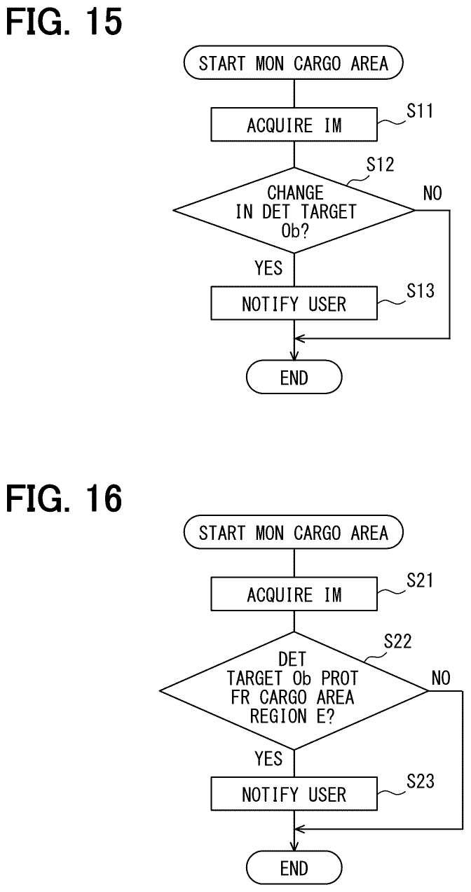

The periphery monitoring ECU 1 mainly includes a microcomputer, and the microcomputer includes a processor 14, a memory, an I/O, and a bus connecting these components. The periphery monitoring ECU 1 corresponds to a control device. The periphery monitoring ECU 1 executes various processes by using the processor 14 to execute control programs stored in the memory. As shown in FIG. 15, the periphery monitoring ECU 1 acquires a cargo area image Gb (at S11), and when detecting a change in the detection target Ob based on the cargo area image Gb (at S12), it notifies the user of the vehicle 6 (at S13). The execution of the processes from S11 to S13 by the processor 14 corresponds to the execution of the notification method.

As shown in FIG. 1, the perimeter monitoring ECU 1 includes an image acquisition unit 10, a region setting unit 11, a cargo area detection unit 12, and a notification processing unit 13. The image acquisition unit 10 acquires the cargo area image Gb, the vehicle stop image Gs, and the restart image Gr from the image unit 5. The image acquisition unit 10 stores the acquired images in a memory. The image acquisition unit 10 stores the first vehicle stop image Gs acquired immediately after the vehicle 6 stops as an image immediately after stopping. The immediately-after-stopping image is a vehicle stop image Gs taken immediately after the vehicle has stopped. The image immediately after stopping is updated when the vehicle 6 starts moving again and stops again.

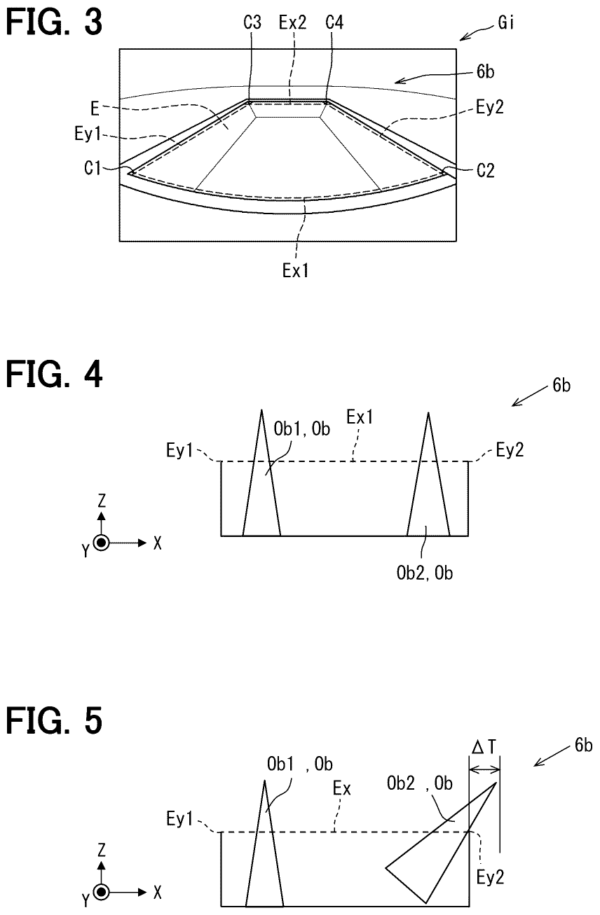

The region setting unit 11 sets a cargo area region E, which is a region within the cargo area 6b, based on operation information of an operation by a user. The cargo area region E is a region set for detecting the protrusion of the detection target Ob from the cargo area 6b. The cargo area region E is set by the user through operation of the touch panel during initial setting of the periphery monitoring ECU 1. The time of initial setting of the periphery monitoring ECU 1 refers to when the periphery monitoring ECU 1 is started for the first time, for example. The cargo area region E may be set at a time other than the initial setting. As shown in FIG. 2 or FIG. 3, the cargo area region E is set as a plane having a predetermined range on the X-Y plane.

### Initial Setting of Cargo Area Region

The region setting unit 11 acquires an initial image Gi, which is a cargo area image Gb in a state where nothing is placed on the cargo area 6b. The initial image Gi is captured when the vehicle 6 is shipped from the factory and is stored in advance in the memory. The periphery monitoring ECU 1 may extract a cargo area image Gb in which nothing is placed on the cargo area 6b from the acquired cargo area images Gb, and set the extracted cargo area image Gb as the initial image Gi. Whether or not there is anything on the cargo area 6b is determined by image recognition technology. The region setting unit 11 controls the display unit 3 to display the initial image Gi. The region setting unit 11 prompts the user to input the four corner points C that define the cargo area region E. The region setting unit 11 sets the cargo area region E based on the four corner points C input by the user.

The cargo area region E is a plane surrounded by four sides Ex1, Ex2, Ey1, and Ey2 connecting the four corner points C. The side Ex1 connects two points C1 and C2 that are located in the negative Y-axis direction (at the front edge of the cargo area) among the points C. The side Ex2 connects two points C3 and C4 that are located in the positive direction of the Y axis (at the rear edge of the cargo area) among the points C. The side Ey1 connects two points C1 and C3 that are located in the negative direction of the X-axis (at the right edge of the cargo area) among the points C. The side Ey2 connects two points C2 and C4 that are located in the positive direction of the X-axis (at the left edge of the cargo area) among the points C.

The cargo area detection unit 12 detects a change in the detection target Ob within the cargo area based on the cargo area image Gb. The detection target Ob is a package or a person. The cargo area detection unit 12 detects a detection target Ob within the cargo area 6b based on the cargo area image Gb. The cargo area detection unit 12 detects a detection target Ob in the cargo area 6b based on image recognition technology. For example, the cargo area detection unit 12 performs image recognition processing such as template matching on the cargo area image Gb to recognize objects present in the image and their types. The cargo area detection unit 12 may detect a change in the detection target Ob by comparing the initial image Gi with the cargo area image Gb.

### Protrusion Detection

The cargo area detection unit 12 detects whether the detection target Ob has fallen from the cargo area 6b or is about to fall from the cargo area 6b. The cargo area detection unit 12 detects a protrusion of the detection target Ob from the cargo area region E by an amount of the protrusion equal to or greater than a protrusion determination value as a change in the detection target Ob. The detection target Ob protruding from the cargo area region E indicates that the detection target Ob protrudes from within the cargo area region E on the X-Y plane. When the detection target Ob does not protrude from the cargo area region E, the detection target Ob exists within the cargo area region E on the X-Y plane. The protrusion detection of the detection target Ob protruding from the cargo area region E by the protrusion amount equal to or greater than the protrusion determination value is performed by the image recognition technology.

FIGS. 4, 5, 6 and 7 are schematic views of the cargo area 6b as viewed from the front side of the vehicle. FIG. 4 is a diagram of the cargo area 6b immediately after the package has been loaded onto the cargo area 6b. In FIG. 4, two detection targets Ob (i.e., detection targets Ob1 and Ob2) are arranged in the cargo area region E. These detection targets Ob do not protrude from the cargo area 6b. The cargo area detection unit 12 stores the cargo area image Gb in the state shown in FIG. 4 in memory as a load image. The load image is a cargo area image Gb immediately after the package has been loaded onto the cargo area 6b. The state immediately after the package is placed on the cargo area 6b is referred to as “immediately after loading.”

The cargo area detection unit 12 determines whether or not loading has just performed by comparing the image with a past cargo area image Gb stored in the memory. For example, when no detection target Ob was detected in a past cargo area image Gb, but a new detection target Ob is detected in the latest cargo area image Gb, the cargo area detection unit 12 determines that the cargo area has just been loaded. The cargo area detection unit 12 also determines that the cargo area has just been loaded if a new detection target Ob is detected when the vehicle starts moving again. The re-start image Gr and the load image may be the same. The load image is used as a comparison image when detecting the change in the cargo area 6b, such as protrusion detection, sway detection, and the like.

The cargo area detection unit 12 detects two detection targets Ob1 and Ob2 in FIG. 4 based on the load image. The cargo area detection unit 12 detects edges (i.e., contour lines) of the detection targets Ob1 and Ob2 in the load image by an edge extraction process. The cargo area detection unit 12 detects whether the edges of the detection targets Ob1 and Ob2 protrude from the cargo area region E by a protrusion determination value or more. In the state of FIG. 4, since the detection targets Ob1 and Ob2 do not protrude beyond the cargo area region E by more than the protrusion determination value, the process of notifying the user is not performed.

FIG. 5 shows the state of the cargo area 6b after a predetermined time has elapsed from that shown in FIG. 4. FIG. 5 is a diagram showing the vehicle 6 while the vehicle is running. FIG. 5 shows an example in which the detection target Ob2 protrudes from the cargo area 6b. The detection target Ob2 is leaning against the edge of the cargo area 6b due to shaking while traveling, and is in a state where it is likely to fall off. The tip of the detection target Ob2 protrudes outward in the X direction beyond the side Ey2 of the cargo area region E by a protrusion amount ΔT. The protrusion amount ΔT is the length by which the detection target Ob protrudes from the cargo area region E. The protrusion amount ΔT may be an area of the detection target Ob protruding from the cargo area region E.

The cargo area detection unit 12 detects two detection targets Ob1 and Ob2 based on the latest cargo area image Gb that has been acquired. The cargo area detection unit 12 detects whether the edges of the detection targets Ob1 and Ob2 protrude from the cargo area region E by a protrusion determination value or more. The cargo area detection unit 12 detects that the edge of the detection target Ob2 protrudes in the X direction by a protrusion amount ΔT. The cargo area detection unit 12 determines whether the protrusion amount ΔT of the detection target Ob2 is equal to or greater than a protrusion determination value.

When the cargo area detection unit 12 detects that the protrusion amount ΔT of the detection target Ob2 is equal to or greater than the protrusion determination value, the cargo area detection unit 12 outputs a signal to the notification processing unit 13 to notify the user. The protrusion determination value is a threshold value used for detecting the protrusion of the detection target Ob. The protrusion determination value is set in advance. The protrusion determination value may be set to any value.

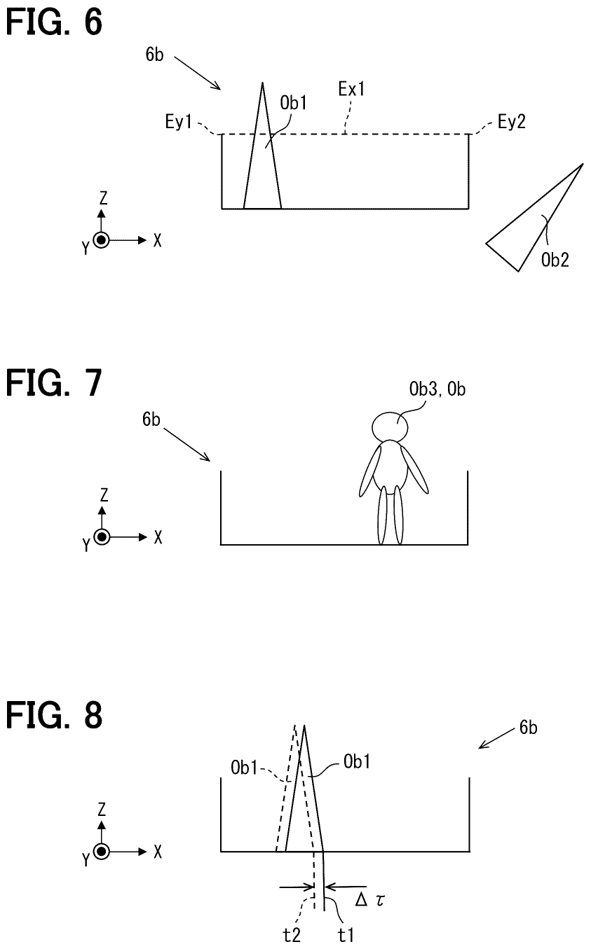

FIG. 6 shows the state of the cargo area 6b after a predetermined time has elapsed from that shown in FIG. 5. FIG. 6 is a diagram showing the vehicle 6 while the vehicle is running. FIG. 6 shows an example in which the detection target Ob2 falls off the cargo area 6b. The detection target Ob2 is in a state where the detection target Ob has completely fallen off the cargo area 6b due to shaking during driving or the like. The detection target Ob2 exists outside the cargo area region E on the X-Y plane. The detection target Ob2 exists outside the imaging range of the image unit 5.

The cargo area detection unit 12 detects the detection target Ob1 based on the latest cargo area image Gb that has been acquired. At this time, the detection object Ob2 is not detected because the detection target Ob2 exists outside the imaging range of the image unit 5. The cargo area detection unit 12 compares the detection result of the latest cargo area image Gb with the detection result of a cargo area image Gb prior to the latest cargo area image Gb (hereinafter, a history image). The history image also includes the load image. The cargo area detection unit 12 detects that the detection target Ob2 has fallen off, based on the fact that the detection target Ob2, which was detected in the history image, was not detected in the latest cargo area image Gb. The cargo area detection unit 12 outputs a signal to the notification processing unit 13 to notify the user that the detection target Ob2 has fallen off.

### Person Detection

The cargo area detection unit 12 detects the presence of a person in the cargo area 6b as a change in the detection target Ob. FIG. 7 shows an example in which a person is present in the cargo area 6b. The cargo area detection unit 12 detects the detection target Ob3 based on the cargo area image Gb, and determines the type of the detection target Ob3. Here, whether the detection target Ob is a person or not is determined by an image recognition technique such as the template matching process. When the cargo area detection unit 12 determines that the detection target Ob3 is a person and is present within the cargo area 6b, the cargo area detection unit 12 outputs a signal to the notification processing unit 13 to notify the user.

### Sway Detection

The cargo area detection unit 12 detects a sway of the detection target Ob equal to or greater than a sway determination value as a change in the detection target Ob. FIG. 8 shows an example in which the detection target Ob1 is swaying due to shaking while driving. The solid line in FIG. 8 indicates the detection target Ob1 at a certain time t1. The dashed line indicates the detection target Ob1 at time t2 when a predetermined time has been elapsed after time t1. In FIG. 8, the detection target Ob1 sways in the X direction by a sway amount Δ_{T} between the time t1 and the time t2. The amount of sway Δ_{T} is the width or length of the sway of the detection target Ob.

The cargo area detection unit 12 determines the swaying of the detection target Ob based on the cargo area images Gb at the time t1 and the time t2. The cargo area detection unit 12 detects the detection target Ob1 based on the cargo area image Gb at time t1, and detects the edges of the detection target Ob1. The cargo area detection unit 12 detects the detection target Ob1 based on the cargo area image Gb at the time t2, and detects the edges of the detection target Ob1. The cargo area detection unit 12 determines whether the detection target Ob1 detected based on the cargo area image Gb at the time t1 and the detection target Ob1 detected based on the cargo area image Gb at the time t2 are the same object. When it is determined that they are the same object, the cargo area detection unit 12 performs a process of detecting the amount of sway Δ_{T} of the detection target Ob1.

The cargo area detection unit 12 compares the edge of the detection target Ob1 detected based on the cargo area image Gb at the time t1 with the edge of the detection target Ob1 detected based on the cargo area image Gb at the time t2, and detects the amount of sway Δ_{T} of the detection target Ob1. When the amount of sway Δ_{T} of the detection target Ob1 is equal to or greater than the sway determination value, the cargo area detection unit 12 outputs a signal to the notification processing unit 13 to notify the user. The sway determination value is a threshold value used for detecting the sway of the detection target Ob. The sway determination value is set in advance. The sway determination value may be set to any value.

### Detecting a Change When the Vehicle Stops and Restarts

The cargo area detection unit 12 detects, as a change in the detection target Ob, whether a change has occurred in the detection target Ob between the vehicle stop vehicle image Gs (mainly an image immediately after stopping) and the restart image Gr. The cargo area detection unit 12 detects the detection target Ob immediately after the vehicle has stopped based on the image immediately after stopping. The cargo area detection unit 12 detects the detection target Ob when the vehicle starts moving again based on the restart image Gr.

The cargo area detection unit 12 detects whether a change has occurred in the detection target Ob between the detection target Ob detected based on the image immediately after stopping (hereinafter, the detection target when stopping) and the detection target Ob detected based on the restart image Gr (hereinafter, the detection target when restarting). A case where a change occurs in the detection target Ob is, for example, a case where the number of detection targets when restarting is changed from the number of detection targets when stopping. If the number of detection targets when restarting decreases compared to the number of detection targets when stopping, it is possible that the detection targets Ob have fallen due to the influence of wind or have been stolen.

Another example of a case where a change has occurred in the detection target Ob is a case where the detection target Ob when stopping and the detection target Ob when restarting are the same object, and the position of the object has moved by a predetermined value or more. When the cargo area detection unit 12 detects that a change has occurred in the detection target Ob between the vehicle stop image Gs and the restart image Gr, the cargo area detection unit 12 outputs a signal to the notification processing unit 13 to notify the user.

### Detecting a Change While Stopping

The cargo area detection unit 12 detects a change in the detection target Ob while the vehicle is stopped. The cargo area detection unit 12 detects whether a change has occurred in the detection target Ob between the multiple vehicle stop vehicle images Gs, as a change in the detection target Ob. The cargo area detection unit 12 detects whether a change has occurred in the detection target Ob based on a plurality of vehicle stop images Gs. The cargo area detection unit 12 detects whether a change has occurred in the detection target Ob between the detection target Ob detected based on the latest acquired vehicle stop image Gs and the detection target Ob detected based on a vehicle stop image Gs acquired before the latest vehicle stop image Gs. When the cargo area detection unit 12 detects that a change has occurred in the detection target Ob, the cargo area detection unit 12 outputs a signal to the notification processing unit 13 to notify the user.

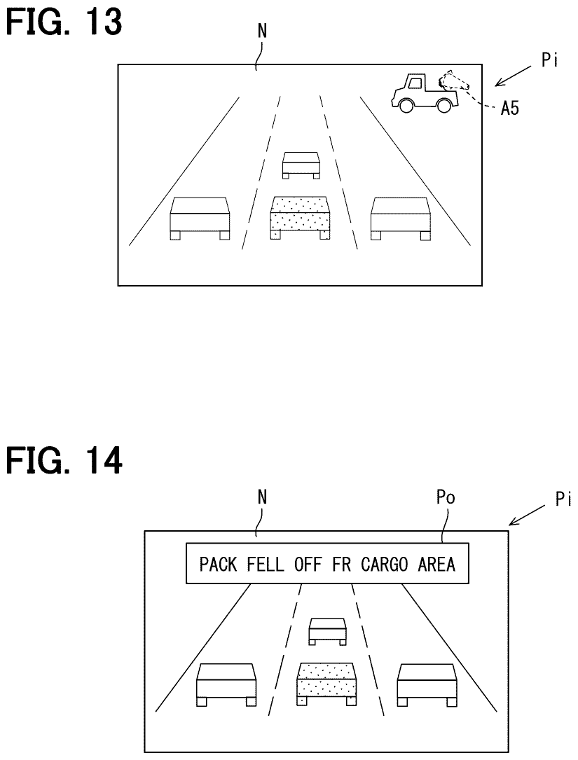

The periphery monitoring ECU 1 also performs processing to recognize the driving environment of the vehicle based on the detection results of sensors that monitor the periphery of the vehicle. For example, the periphery monitoring ECU 1 recognizes road signs and the presence or absence of obstacles from images acquired by a camera that captures the view ahead of the vehicle 6 by image recognition processing such as a pattern matching process. The periphery monitoring ECU 1 controls so as to output a periphery monitoring image N (see FIGS. 13 and 14) related to the autonomous driving periphery monitoring system to the display unit 3.

When the cargo area detection unit 12 detects a change in the detection target Ob, the notification processing unit 13 performs processing to notify the user of the vehicle 6 of the change in the detection target Ob by at least one of sound output by the sound output unit 4 and the display of a notification image Pi by the display unit 3. The notification processing unit 13 determines the notification mode. The notification processing unit 13 determines at least one of a sound output and a notification image Pi as the notification mode. The notification mode is determined depending on the state of the vehicle 6 or the content of the change in the detection target Ob. The notification processing unit 13 determines the timing of the notification. The timing of the notification is determined according to the state of the vehicle 6 or the content of the change in the detection target Ob, and the like.

The notification processing unit 13 generates sound output data for causing the sound output unit 4 to output the sound. The notification processing unit 13 generates image output data for displaying the notification image Pi on the display unit 3. The sound output data includes data relating to the sound to be output and information indicating the timing of sound output. The image output data includes data of the notification image Pi and information indicating the display timing.

The sound output by the sound output unit 4 may be set to any sound as long as it is a sound that notifies the user of the vehicle 6 of a change in the cargo area 6b. The sound output by the sound output unit 4 may be a notification sound (i.e., alarm sound) with a predetermined pattern or a voice message.

The notification image Pi to be displayed on the display unit 3 may be set to any image as long as it is a display for notifying the user of the vehicle 6 of a change in the cargo area 6b. The notification image Pi is an image generated mainly based on the cargo area image Gb, for example. The notification image Pi displays icons A1 to A5 on a cargo area image Gb. The icons A1 to A5 are icons that indicate changes in the cargo area 6b. The notification image Pi is a pop-up Po to be displayed on a cargo area image Gb.

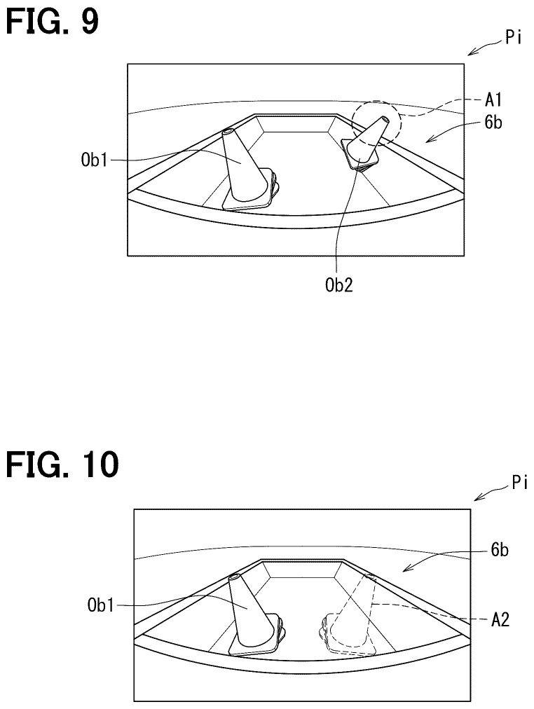

FIG. 9 is an example of a notification image Pi when the protrusion of the detection target Ob2 is detected. In the notification image Pi, an icon A1 is superimposed on a cargo area image Gb. The icon A1 is an image that highlights the detection target Ob2 in which the protrusion has been detected.

FIG. 10 is an example of a notification image Pi when the detection target Ob falls off. In the notification image Pi, an icon A2 is superimposed on a cargo area image Gb. The icon A2 is an image that emphasizes the detection target Ob2 that was detected to have fallen off the cargo area 6b. The icon A2 is generated by extracting the outline of the detection target Ob2 before it falls off based on the history image.

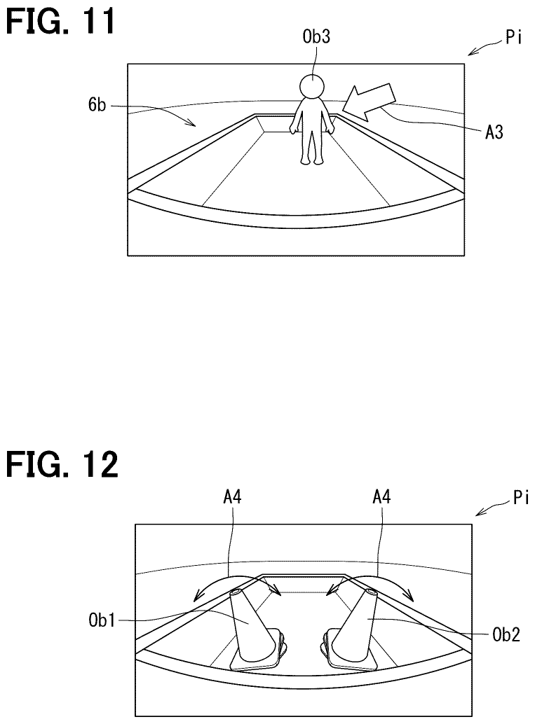

FIG. 11 is an example of a notification image Pi when a person is detected in the cargo area 6b. In the notification image Pi, an icon A3 is superimposed on a cargo area image Gb. The icon A3 is an arrow-shaped image that emphasizes the detected detection target Ob3 (i.e., the person).

FIG. 12 is an example of a notification image Pi when the sway of the detection targets Ob1 and Ob2 is detected. In the notification image Pi, an icon A4 is superimposed on a cargo area image Gb. The icon A4 is displayed near the detection targets Ob1 and Ob2 whose sway has been detected, and is an arrow-shaped image indicating the sway.

FIG. 13 is an example of a notification image Pi when the protrusion and the falling-off of the detection target are detected. The display unit 3 displays a periphery monitoring image N related to the autonomous driving periphery monitoring system. In the notification image Pi, an icon A5 is superimposed on the periphery monitoring image N. The icon A5 is an image indicating that the protrusion has been detected.

FIG. 14 is another example of a notification image Pi when the protrusion and the falling-off of the detection target are detected. In the notification image Pi, a pop-up Po is superimposed on a periphery monitoring image N. The pop-up Po is an image indicating that protrusion has been detected. The pop-up Po includes a character string indicating that a package has fallen off from the cargo area 6b.

### Flowchart for Detecting Protrusion

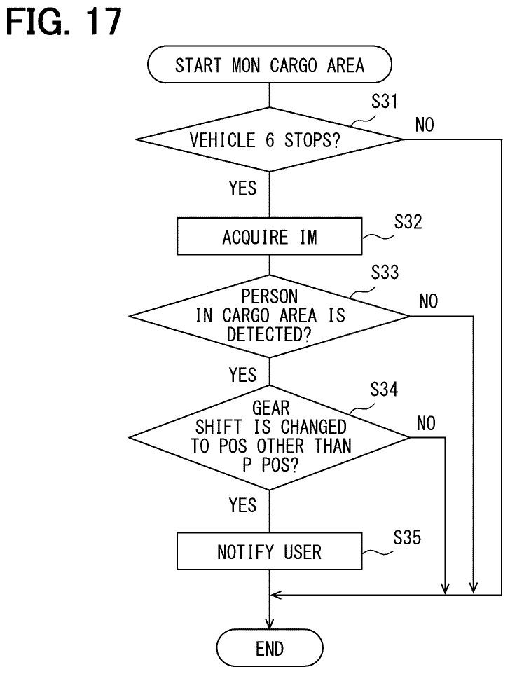

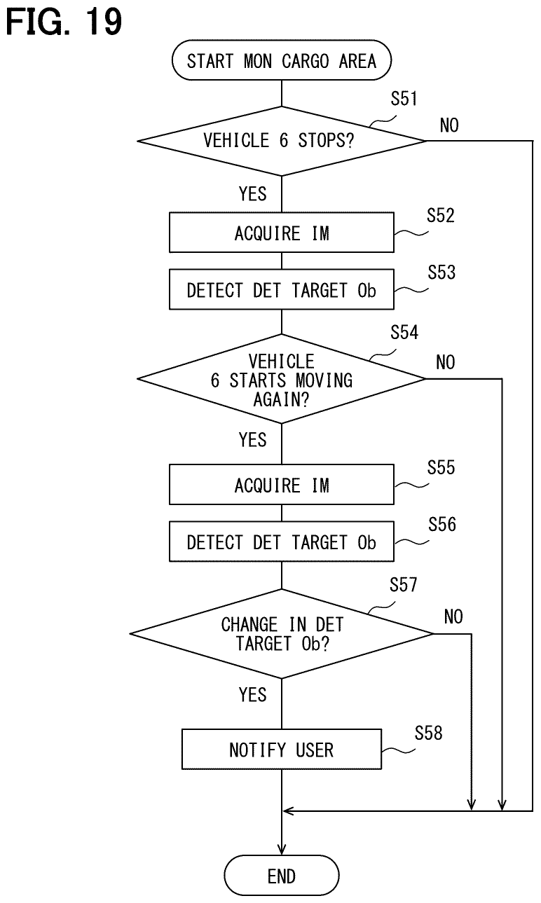

The cargo area monitoring process shown in FIG. 16 is started when the ignition switch of the vehicle 6 is turned on. The cargo area monitoring process is a process of monitoring the cargo area 6b, and, when a change in the detection target Ob is detected, a process of notifying the user of the vehicle 6 of the change in the detection target Ob. The cargo area monitoring process includes detection of protrusion, detection of person, detection of swaying, detection of changes between when the vehicle stops and when the vehicle starts moving again, and detection of changes while the vehicle is in a stop state. The cargo area monitoring process is repeated while the ignition switch is in the on state. The same applies to the other flowcharts in FIG. 17 to FIG. 19.

In S21, the image acquisition unit 10 acquires a cargo area image Gb. In S22, the cargo area detection unit 12 performs the protrusion detection. The process of detecting the protrusion of the detection target in S22 is mainly performed before the vehicle 6 starts moving or while the vehicle 6 is running, alternatively, the process may be performed while the vehicle is in the stop state. The cargo area detection unit 12 detects a protrusion of the detection target Ob from the cargo area region E by a protrusion determination value or more as a change in the detection target Ob based on the latest acquired cargo area image Gb. In S23, the notification processing unit 13 performs control so as to notify the user of the change in the detection target Ob. The notification processing unit 13 determines the notification mode. As an example, the notification processing unit 13 here performs control so as to both the sound output and the display of the notification image Pi.

The notification processing unit 13 determines the timing of the notification. The notification processing unit 13 determines the timing of the sound output and the image output. When the vehicle 6 is in the stop state before starting, the notification processing unit 13 performs control so as to give a notification when the shift lever is switched to a position other than the P position. The notification processing unit 13 generates the sound output data for notifying that there is a detection target Ob protruding from the cargo area region E. The notification processing unit 13 generates the image output data for notifying that there is a detection target Ob protruding from the cargo area region E. The notification processing unit 13 generates, as the notification image Pi, an image in which an icon A1 for emphasizing the detection target Ob whose protrusion has been detected is superimposed on the cargo area image Gb as shown in FIG. 9.

The notification processing unit 13 transmits the sound output data to the sound output unit 4. The notification processing unit 13 transmits the image output data to the display unit 3. The display unit 3 displays a notification image Pi when the shift lever is switched to a position other than the P position. The sound output unit 4 outputs a sound when the shift lever is switched to a position other than the P position.

The timing of the sound output and the display of the notification image Pi may be any other timing. The timing of the sound output and image output may be immediately after the protrusion detection in S21. The notification to the user may be either a sound output or a display of the notification image Pi. The notification processing unit 13 may display a notification image Pi after outputting the sound. The notification processing unit 13 may output a sound after displaying the notification image Pi. The notification processing unit 13 may output a sound while the vehicle 6 is running, and thereafter display a notification image Pi in response to a user operation.

### Person Detection Flow Chart

FIG. 17 is a flowchart of person detection. In S31, the periphery monitoring ECU 1 determines whether the vehicle 6 is stopped. The periphery monitoring ECU 1 determines that the vehicle is stopped when the shift lever is in the P position. The periphery monitoring ECU 1 may determine that the vehicle is stopped when the shift lever is in the P position and the parking brake is in the on state.

In S32, the image acquisition unit 10 acquires a vehicle stop image Gs. In S33, the cargo area detection unit 12 detects a person. The cargo area detection unit 12 determines whether or not a person is present in the cargo area 6b based on the most recently acquired vehicle stop image Gs. If the determination is “YES” in S32, the notification processing unit 13 determines the timing of notification so as to notify when the shift lever is switched to a position other than the P position.

The notification processing unit 13 generates the sound output data for notifying that a person has been detected in the cargo area 6b. The notification processing unit 13 generates the image output data for notifying that a person has been detected in the cargo area 6b. The notification processing unit 13 generates, as the notification image Pi, an image in which an icon A3 emphasizing the detected person is superimposed on the cargo area image Gb as shown in FIG. 11. The notification processing unit 13 transmits the sound output data to the sound output unit 4. The notification processing unit 13 transmits the image output data to the display unit 3.

In S34, the shift position sensor 20 detects that the shift lever has been changed to a position other than the P position. The state detection unit 2 transmits a signal to the sound output unit 4 and the display unit 3 to notify that the shift lever has been changed to a position other than the P position. In S35, the display unit 3 displays the notification image Pi, and the sound output unit 4 outputs sound.

The timing of the notification to the user may be any other timing. The timing of the sound output and image output may be immediately after the person detection in S33. The notification to the user may be either a sound output or a display of the notification image Pi. The notification processing unit 13 may output a sound after displaying the notification image Pi. The notification processing unit 13 may output a sound first, and thereafter display a notification image Pi in response to a user operation.

### Flowchart for Detecting Sway

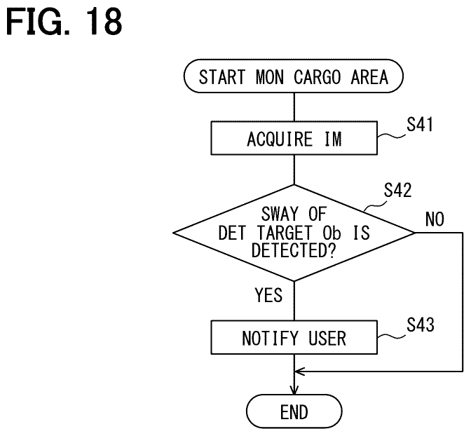

FIG. 18 is a flow chart of the sway detection. In S41, the image acquisition unit 10 acquires a cargo area image Gb. In S42, the cargo area detection unit 12 performs the sway detection. The sway detection process in S42 is mainly performed while the vehicle 6 is running, alternatively may be performed while the vehicle is stopped. The cargo area detection unit 12 detects the sway of the detection target Ob that is equal to or greater than the sway determination value based on the latest cargo area image Gb acquired.

In S43, the notification processing unit 13 performs control so as to notify the user of the change in the detection target Ob. The notification processing unit 13 determines the notification mode. As an example, it is assumed here that the vehicle 6 is running. The notification processing unit 13 first outputs a sound, and then performs control so as to display a notification image Pi in response to a user operation.

The notification processing unit 13 determines the timing of the notification. The notification processing unit 13 determines the timing of the sound output. The notification processing unit 13 performs control so as to immediately output sound. The notification processing unit 13 generates the sound output data for notifying of the sway of the detection target Ob that is equal to or greater than the sway determination value. The notification processing unit 13 generates the image output data for notifying that a sway equal to or greater than the sway determination value of the detection target Ob has been detected. The notification processing unit 13 generates, as the notification image Pi, an image in which an icon A4 indicating the sway of the detection target Ob, the sway of which has been detected, is superimposed on the cargo area image Gb as shown in FIG. 13.

The notification processing unit 13 transmits the sound output data to the sound output unit 4. The notification processing unit 13 transmits the image output data to the display unit 3. The sound output unit 4 outputs the sound based on the sound output data. The display unit 3 displays a notification image Pi in response to an operation by the user.

The timing of the sound output and the display of the notification image Pi may be any other timing. The notification to the user may be either a sound output or a display of the notification image Pi. The notification processing unit 13 may output a sound after displaying the notification image Pi.

### Flowchart of Change Detection When the Vehicle Stops and Restarts

In S51, the periphery monitoring ECU 1 determines whether the vehicle 6 is stopped. In S52, the image acquisition unit 10 acquires an image immediately after the vehicle stops. In S53, the cargo area detection unit 12 detects the detection target Ob based on the image taken immediately after the vehicle stops.

In S54, the shift position sensor 20 detects that the shift lever has been changed to a position other than the P position. The state detection unit 2 transmits a signal to the periphery monitoring ECU 1 to notify that the shift lever has been changed to a position other than the P position. In S55, the image acquisition unit 10 acquires a restart image Gr. In S56, the cargo area detection unit 12 detects the detection target Ob based on the restart image Gr.

In S57, the cargo area detection unit 12 detects a change between when the vehicle stops and when the vehicle starts moving again. The cargo area detection unit 12 detects whether a change has occurred in the detection target Ob between the detection target when the vehicle stops and the detection target when the vehicle starts moving again. In S58, the notification processing unit 13 performs control so as to notify the user of the change in the detection target Ob. The notification processing unit 13 determines the notification mode. As an example, the notification processing unit 13 here performs control so as to both the sound output and the display of the notification image Pi. The notification processing unit 13 determines the timing of the notification. The notification processing unit 13 determines the timing of the sound output and the display of the notification image Pi. The notification processing unit 13 performs control so as to immediately output the sound and display the notification image Pi.

The notification processing unit 13 generates the sound output data for notifying that a change has occurred in the detection target Ob between when the vehicle stops and when the vehicle starts moving again. The notification processing unit 13 generates the image output data for notifying that a change has occurred in the detection target Ob between when the vehicle stops and when the vehicle starts moving again. The notification processing unit 13 generates, as the notification image Pi, an image in which an icon emphasizing the detection target Ob in which a change has been detected is superimposed on the cargo area image Gb. The notification processing unit 13 transmits the sound output data to the sound output unit 4. The notification processing unit 13 transmits the image output data to the display unit 3.

The timing of the notification to the user may be any other timing. The notification to the user may be either a sound output or a display of the notification image Pi. The notification processing unit 13 may output a sound after displaying the notification image Pi. The notification processing unit 13 may output a sound first, and thereafter display a notification image Pi in response to a user operation.

In the above description of the flowchart, the cargo area detection unit 12 detects a change between when the vehicle stops and when the vehicle restarts based on the image immediately after the vehicle stops and the restart image Gr, but the present embodiments are not necessarily limited to this feature. The cargo area detection unit 12 may detect a change between when the vehicle stops and when the vehicle restarts, based on the vehicle stop image Gs other than the image immediately after stopping and the restart image Gr.

### Flowchart of Change Detection While the Vehicle is Stopped

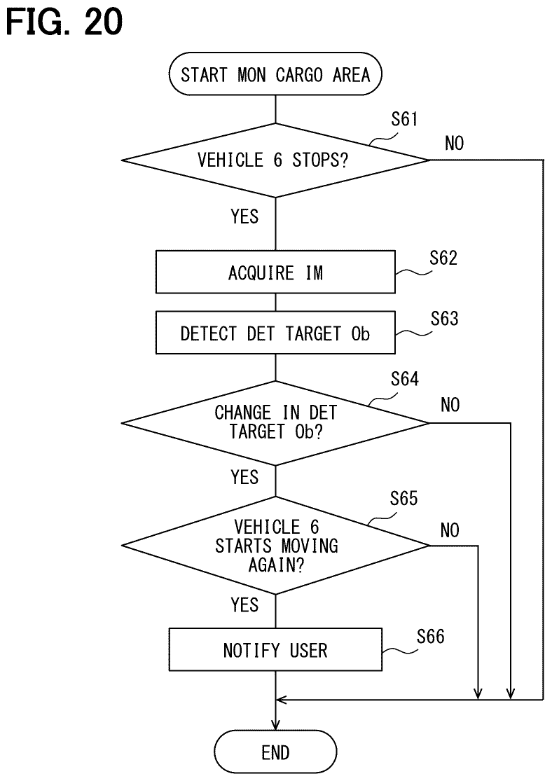

Here, detection of a change while the vehicle is stopped by the periphery monitoring ECU 1 will be described (see FIG. 20). In S61, the periphery monitoring ECU 1 determines whether the vehicle 6 is stopped. In S62, the image acquisition unit 10 acquires a vehicle stop image Gs. In S63, the cargo area detection unit 12 detects the detection target Ob based on the most recently acquired vehicle stop image Gs.

In S64, the cargo area detection unit 12 detects a change in the detection target Ob while the vehicle is stopped. The cargo area detection unit 12 detects whether a change has occurred in the detection target Ob based on a plurality of vehicle stop images Gs. The cargo area detection unit 12 detects whether a change has occurred in the detection target Ob between the detection target Ob detected based on the latest acquired vehicle stop image Gs and the detection target Ob detected based on a vehicle stop image Gs acquired before the latest vehicle stop image Gs. If there is no vehicle stop image Gs acquired before the latest vehicle stop image Gs, the flow chart ends.

If the result of S64 is “YES”, the notification processing unit 13 performs control so as to notify the user of the change in the detection target Ob. The notification processing unit 13 determines the notification mode. As an example, the notification processing unit 13 here performs control so as to both the sound output and the display of the notification image Pi. The notification processing unit 13 determines the timing of the notification. The notification processing unit 13 determines the timing of the sound output and the display of the notification image Pi. The notification processing unit 13 performs control so as to notify when the shift lever is switched to a position other than the P position.

The notification processing unit 13 generates the sound output data for notifying that a change has occurred in the detection target Ob while the vehicle is stopped. The notification processing unit 13 generates the image output data for notifying that a change has occurred in the detection target Ob while the vehicle is stopped. The notification processing unit 13 generates, as the notification image Pi, an image in which an icon emphasizing the detection target Ob in which a change has been detected is superimposed on the cargo area image Gb. The notification processing unit 13 transmits the sound output data to the sound output unit 4. The notification processing unit 13 transmits the image output data to the display unit 3.

In S65, the shift position sensor 20 detects that the shift lever has been changed to a position other than the P position. The state detection unit 2 transmits a signal to the periphery monitoring ECU 1 to notify that the shift lever has been changed to a position other than the P position. In S66, the display unit 3 displays the notification image Pi, and the sound output unit 4 outputs sound.

The timing of the notification to the user may be any other timing. The timing of the sound output and the image output may be immediately after the change is detected in S64. The notification to the user may be either a sound output or a display of the notification image Pi. The notification processing unit 13 may output a sound after displaying the notification image Pi. The notification processing unit 13 may output a sound first, and thereafter display a notification image Pi in response to a user operation.

After the user is notified in S66, the sound output and the display of the notification image Pi may be stopped in response to an operation by the user.

### Overview of Embodiments

According to the embodiments, when a change in the detection target Ob within the cargo area 6b is detected based on a cargo area image Gb photographed of the cargo area 6b, the user is notified of the change in the detection target Ob by at least one of the sound output and the display of a notification image Pi. In this way, a change in the detection target Ob is used as a trigger to notify the user, so that it is easier for the user to recognize the change in the detection target Ob in the cargo area 6b.

According to the embodiments, the user is notified that the detection target Ob has protruded beyond the cargo area region E by an amount equal to or greater than the protrusion determination value. This allows the user to know that the detection target Ob is about to fall outside the cargo area 6b or has already fallen outside.

The region setting unit 11 sets the cargo area region E based on the operation information. This allows the cargo area region E to be set according to the user's preferences.

According to the embodiments, the user is notified that a person is present in the cargo area 6b. This allows the user to know that there is a person in the cargo area 6b, making it possible to prevent an accident.

According to the embodiments, the user is notified that the detection target Ob is swaying to an extent equal to or greater than the sway determination value. This allows the user to know that the detection target Ob is not fixed sufficiently.

According to the embodiments, the user is notified that there has been a change in the detection target Ob between when the vehicle stops and when the vehicle restarts. This allows the user to know that there has been a change in the detection target Ob between when the vehicle stops and when the vehicle restarts.

According to the embodiments, the user is notified that there has been a change in the detection target Ob while the vehicle is stopped. This allows the user to know that there has been a change in the detection target Ob while the vehicle is stopped.

### Modifications

Although the configuration in which the cargo area region E is set by the user has been described, it is not necessarily limited to this feature. The cargo area region E may be preset at the time of shipment from the factory.

The region setting unit 11 is configured to set the cargo area region E based on the four corner points C input by the user, but the present embodiments are not necessarily limited to this feature. The region setting unit 11 may automatically recognize the four corners of the cargo area 6b based on the cargo area image Gb and automatically set the cargo area region E.

In the above embodiments, the periphery monitoring ECU 1 notifies the user through the notification processing unit 13 when it determines that a person is present in the cargo area 6b. However, the present embodiments are not necessarily limited to this feature. The periphery monitoring ECU 1 may notify the user when it determines that a person is present around the cargo area 6b.

Although the periphery monitoring ECU 1 has been described to have a configuration including the image acquisition unit 10, the region setting unit 11, the cargo area detection unit 12, and the notification processing unit 13, the configuration is not necessarily limited to this feature. The imaging unit 5 may include some or all of the region setting unit 11, the cargo area detection unit 12, and the notification processing unit 13.

### Technical Feature

The embodiments teaches multiple technical features described in multiple items listed below. Some items may be written in a multiple dependent form with subsequent items referring to the preceding item as an alternative. Alternatively, some features may be described in a multiple dependent form referring to another multiple dependent form. These features described in a multiple dependent form define multiple technical features.

### Technical Feature 1

A control device for a vehicle includes: at least one of (i) a circuit and (ii) a processor having a memory storing computer program code. The at least one of the circuit and the processor having the memory is configured to cause the control device to provide: an image acquisition unit that acquires a cargo area image captured by an image device that captures an image of a cargo area of the vehicle; a cargo area detection unit that detects a change in a detection target in the cargo area based on the cargo area image; and a notification processing unit that notifies a user of the vehicle of the change in the detection target by at least one of sound output by a sound output unit and a display of a notification image by an image output unit when the cargo area detection unit detects the change of the detection target.

### Technical Feature 2

The control device according to technical feature 1, further includes: a region setting unit for setting a cargo area region which is a region within the cargo area. The cargo area detection unit detects, as the change in the detection target, a protrusion of the detection target from the cargo area region by a protrusion determination value or more. The notification processing unit notifies the user when the cargo area detection unit detects the protrusion equal to or greater than the protrusion determination value.

### Technical Feature 3

In the control device according to technical feature 2, the region setting unit sets the cargo area region based on operation information of an operation by the user.

### Technical Feature 4

In the control device according to any one of technical features 1 to 3, the cargo area detection unit detects presence of a person in the cargo area as the change in the detection target. The notification processing unit notifies the user when the cargo area detection unit detects that the person is present in the cargo area.

### Technical Feature 5

In the control device according to any one of technical features 1 to 4, the cargo area detection unit detects a sway of the detection target that is equal to or greater than a sway determination value as the change in the detection target. The notification processing unit notifies the user when the cargo area detection unit detects the sway equal to or greater than the sway determination value.

### Technical Feature 6

In the control device according to any one of technical features 1 to 5, the image acquisition unit acquires a vehicle stop image which is an image of the cargo area when the vehicle stops, and acquires a restart image which is an image of the cargo area when the vehicle restarts. The cargo area detection unit detects whether the change has occurred in the detection target between the vehicle stop image and the restart image. The notification processing unit notifies the user when the cargo area detection unit detects that the change has occurred in the detection target between the vehicle stop image and the restart image.

### Technical Feature 7

In the control device according to any one of technical features 1 to 6, the image acquisition unit acquires a plurality of vehicle stop images which are images of the cargo area when the vehicle is stopped. The notification processing unit notifies the user when the cargo area detection unit detects that the change has occurred in the detection target between the plurality of vehicle stop images.

In the present disclosure, the term “processor” may refer to a single hardware processor or several hardware processors that are configured to execute computer program code (i.e., one or more instructions of a program). In other words, a processor may be one or more programmable hardware devices. For instance, a processor may be a general-purpose or embedded processor and include, but not necessarily limited to, CPU (a Central Processing Circuit), a microprocessor, a microcontroller, and PLD (a Programmable Logic Device) such as FPGA (a Field Programmable Gate Array).

The term “memory” in the present disclosure may refer to a single or several hardware memory configured to store computer program code (i.e., one or more instructions of a program) and/or data accessible by a processor. A memory may be implemented using any suitable memory technology, such as static random-access memory (SRAM), synchronous dynamic RAM (SDRAM), nonvolatile/Flash-type memory, or any other type of memory. Computer program code may be stored on the memory and, when executed by a processor, cause the processor to perform the above-described various functions.

In the present disclosure, the term “circuit” may refer to a single hardware logical circuit or several hardware logical circuits (in other words, “circuitry”) that are configured to perform one or more functions. In other words (and in contrast to the term “processor”), the term “circuit” refers to one or more non-programmable circuits. For instance, a circuit may be IC (an Integrated Circuit) such as ASIC (an application-specific integrated circuit) and any other types of non-programmable circuits.

In the present disclosure, the phrase “at least one of (i) a circuit and (ii) a processor” should be understood as disjunctive (logical disjunction) where the circuit and the processor can be optional and not be construed to mean “at least one of a circuit and at least one of a processor”. Therefore, in the present disclosure, the phrase “at least one of a circuit and a processor is configured to cause a cargo area monitoring system to perform functions” should be understood that (i) only the circuit can cause a cargo area monitoring system to perform all the functions, (ii) only the processor can cause a cargo area monitoring system to perform all the functions, or (iii) the circuit can cause a cargo area monitoring system to perform at least one of the functions and the processor can cause a cargo area monitoring system to perform the remaining functions. For instance, in the case of the above-described (iii), function A and B among the functions A to C may be implemented by a circuit, while the remaining function C may be implemented by a processor.

It is noted that a flowchart or the processing of the flowchart in the present application includes sections (also referred to as steps), each of which is represented, for instance, as S11. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A control device for a vehicle comprising:
an image acquisition unit that acquires a cargo area image captured by an image device that captures an image of a cargo area of the vehicle;
a cargo area detection unit that detects a change in a detection target in the cargo area based on the cargo area image; and
a notification processing unit that notifies a user of the vehicle of the change in the detection target by at least one of sound output by a sound output unit and a display of a notification image by an image output unit when the cargo area detection unit detects the change of the detection target.

2. The control device according to claim 1, further comprising:
a region setting unit that sets a cargo area region which is a region within the cargo area, wherein:
the cargo area detection unit detects, as the change in the detection target, a protrusion of the detection target from the cargo area region by a protrusion determination value or more; and
the notification processing unit notifies the user when the cargo area detection unit detects the protrusion equal to or greater than the protrusion determination value.

3. The control device according to claim 2, wherein:
the region setting unit sets the cargo area region based on operation information of an operation by the user.

4. The control device according to claim 1, wherein:
the cargo area detection unit detects presence of a person in the cargo area as the change in the detection target; and
the notification processing unit notifies the user when the cargo area detection unit detects the presence of the person in the cargo area.

5. The control device according to claim 1, wherein:
the cargo area detection unit detects a sway of the detection target that is equal to or greater than a sway determination value as the change in the detection target; and
the notification processing unit notifies the user when the cargo area detection unit detects the sway equal to or greater than the sway determination value.

6. The control device according to claim 1, wherein:
the image acquisition unit acquires a vehicle stop image which is an image of the cargo area when the vehicle stops, and acquires a restart image which is an image of the cargo area when the vehicle restarts;
the cargo area detection unit detects whether the change has occurred in the detection target between the vehicle stop image and the restart image; and
the notification processing unit notifies the user when the cargo area detection unit detects that the change has occurred in the detection target between the vehicle stop image and the restart image.

7. The control device according to claim 1, wherein:
the image acquisition unit acquires a plurality of vehicle stop images which are images of the cargo area when the vehicle is stopped; and
the notification processing unit notifies the user when the cargo area detection unit detects that the change has occurred in the detection target between the plurality of vehicle stop images.

8. The control device according to claim 1, further comprising:
at least one of (i) a circuit and (ii) a processor having a memory storing computer program code, wherein:
the at least one of the circuit and the processor having the memory is configured to cause the control device to provide at least one of: the image acquisition unit; the cargo area detection unite; and the notification processing unit.

9. A cargo area monitoring system for a vehicle comprising:
an image device for photographing a cargo area of a vehicle; and
a control device, wherein:
the control device includes:
an image acquisition unit that acquires a cargo area image photographed by the image device;
a cargo area detection unit that detects a change in a detection target in the cargo area based on the cargo area image; and
a notification processing unit that notifies a user of the vehicle of the change in the detection target by at least one of sound output by a sound output unit and a display of a notification image by an image output unit when the cargo area detection unit detects the change of the detection target.

10. The cargo area monitoring system for a vehicle according to claim 9, wherein:
the control device further includes at least one of (i) a circuit and (ii) a processor having a memory storing computer program code; and
the at least one of the circuit and the processor having the memory is configured to cause the control device to provide at least one of: the image acquisition unit; the cargo area detection unite; and the notification processing unit.

11. A notification method for a vehicle comprising a process executed by at least one processor, wherein:
the process includes:
acquiring a cargo area image photographed by an image device that photographs a cargo area of the vehicle;
detecting a change in a detection target in the cargo area based on the cargo area image; and
notifying a user of the vehicle of the change of the detection target by at least one of sound output from a sound output unit and a display of a notification image from an image output unit when detecting the change in the detection target.
